(19) United States
(12) Patent Application Publication
(10) Pub. No.: US 2025/0384194 A1
(43) Pub. Date: Dec. 18, 2025

(54) INTEGRATED CIRCUIT PACKAGE DESIGN AND COST ESTIMATION SYSTEM

(71) Applicant: Intel Corporation, Santa Clara, CA (US)

(72) Inventor: Takuya ABE, Chandler, AZ (US)

(21) Appl. No.: 18/744,414

(22) Filed: Jun. 14, 2024

(51) Int. Cl. G06F 30/33; G06F 30/31; G06F 119/08

(52) U.S. Cl. CPC G06F 30/33; G06F 30/31; G06F 2119/08

(57) ABSTRACT

In some embodiments, an advanced packaging design and cost estimation system is provided. It may include a user interface incorporating a 3D canvas area where users can drag and drop packaging objects to model real world chiplets and packaging architecture scenarios and receive feedback on the predicted costs.

### TECHNICAL FIELD

Embodiments relate to the field of integrated circuit (IC) packages; and more specifically, to tools for designing IC packages and generating cost estimates for the same.

### BRIEF DESCRIPTION OF THE DRAWINGS

FIGS. 1A-1C are diagrams showing several different advanced packaging techniques for combining multiple dies into a common IC package.

FIG. 2 is a hybrid data flow diagram showing how an ML based IC package cost estimate model may be generated and utilized in accordance with some embodiments.

FIG. 3 shows an exemplary data set template for an IC package cost estimate model in accordance with some embodiments.

FIG. 4 is a diagram illustrating an IC package cost estimation tool in accordance with some embodiments.

FIG. 5 is a flow diagram showing a process of estimating product unit cost through the application of the 3D interface of FIG. 4 in accordance with some embodiments.

FIG. 6 shows an exemplary user interface display in accordance with some embodiments.

FIG. 7 is a block diagram of a server based network compute system for implementing an IC package design and cost estimation system in accordance with some embodiments.

### DETAILED DESCRIPTION

There are a variety of different techniques in the realm of advanced packaging for assembling together multiple dies (or chiplets) into a common integrated circuit (IC) package. For example, 2.5D packaging involves positioning two or more chips side by side with an interposer or bridge connecting them. This approach improves performance and power efficiency by facilitating faster data transfer between the chips. Another technique is 3D packaging, which places multiple chips on top of each other using methods such as through-silicon vias (TSVs) and micro-bumps or with hybrid bonding using suitable bonding contacts.

The former involves vertical electrical connections through the silicon die or wafer, while the latter may utilize a dielectric bond and embedded metal. Both 2.5, 3D stacking, and combinations of both 2.5 and 3D stacking can enhance memory and processing capabilities, making them suitable for a wide variety of advanced compute applications. They allow for the integration of multiple chips, passive components, and other elements into a single package, which optimizes space utilization, reduces power consumption, and enhances system performance.

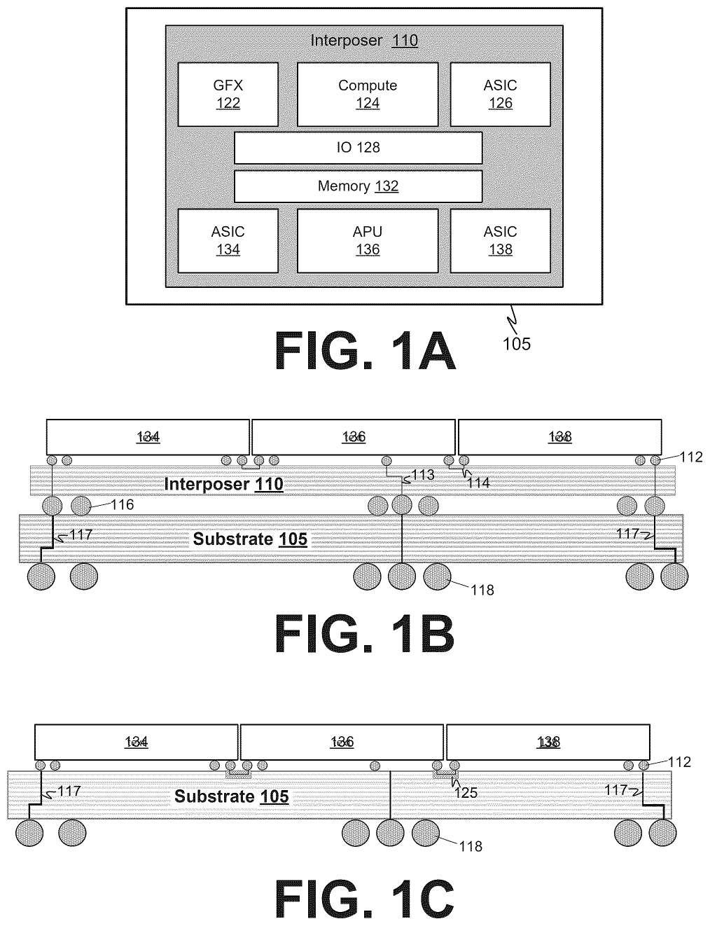

FIGS. 1A-1C are diagrams showing several different advanced packaging techniques for combining multiple dies (also referred to as chiplets or dielets) into a common IC package. FIG. 1A is a top view showing multiple dies (122-138) mounted atop an interposer 110, which in turn, is mounted to a substrate 105. In this way, different types of chips (e.g., central processing units, graphics processing nits, artificial intelligence accelerators, etc.) may be combined into a single package for improved performance and energy efficiency.

FIG. 1B is a side view of the IC package of FIG. 1A. Shown are dies 134, 136, and 138 mounted to interposer 110 through micro-bumps 112. The interposer may have one or more conductive vias, or pillars, 113 and metal layer traces 114 for electrically coupling the dies to one another, as well as for connections to power, ground, and off-package input/output contacts. In turn, interposer 110 is connected to substrate 105 through bumps 116, which connect to other chip contacts and off-package bumps 118 through vias, pillars, and/or wires 117.

FIG. 1C shows the package but with embedded bridges instead of an interposer. The depicted chips (134-138) are mounted directly to the substrate 105 and communicatively connected to each other through bridges 125, which are embedded into the substrate.

Bridges, interposers and different types of substrates, along with different types of 3D stacking techniques, may be used separately or together, depending on particular design objectives. Different material types such as organic substrates, copper interconnects, and advanced dielectrics improve thermal conductivity and electrical performance while reducing overall package size. Molding compounds with a lower coefficient of thermal expansion (CTE) may also be used.

Advanced packaging also involves using reliable interconnects, well-defined signal paths, and minimization of nuisance effects like insertion losses, interconnect crosstalk, substrate warpage, and hot spots in the system. Those parameters can vary significantly depending on the choice of package objects, which can be anything from 2.5D with interposers, organic, silicon, or other, fan-out chip-on-substrate (FOCoS), 3D stacks, or bridges that may be used separately or in conjunction with the other approaches.

For example, silicon interposers or bridges may provide high bandwidth communications, while organic interposers are generally less expensive and can embed passives along interconnect routes from redistribution layers to C4 bumping. A key advantage, in addition to the high-bandwidth, high-speed communication in silicon interposers, is the flexibility in die routing for ground traces around the I/O signals, which reduces the crosstalk. Other materials such as glass may be used. For example, with glass substrates, the needs for interposers may be removed. In other implementations, instead of rigid glass substrates, fan-out approaches with silicon bridges may be used to reduce the need for costly multi-layer laminate substrates. Bridge methods can deliver other benefits on the performance side. Other options to package designers include backside power delivery, which places power delivery to transistors on a wafer's backside, while signal lines are carried on the frontside. Backside power delivery can improve reliability while paving the way to integrating simple devices on the backside as well.

Thus, it can be seen that IC package designs may be implemented in numerous different ways with differing associated effects including performance, reliability and cost. With advanced packaging design, cost is a critical decision metric to narrow down Product Architecture options. Unfortunately, traditional costing methodologies can be excessively time consuming and can support only a limited number of different design scenarios.

Thus, it can be seen that new unit design and cost estimation methodologies would be desired. Accordingly, in some embodiments, an advanced packaging cost estimate system is provided. It may include a user interface incorporating a 3D canvas area where users can drag and drop packaging objects to model real world chiplets and packaging architecture scenarios and receive feedback on the predicted costs. In some embodiments, the cost prediction system uses machine learning (ML) models trained to make predictions of novel packaging architecture scenarios with limited design inputs. Among other things, this can expedite time to market for market segments by speeding up early stage architecture selection. Users are able to generate cost estimates of products in real-time as they modify and/or refine their designs, seeing how such changes will affect the cost and feasibility of the product.

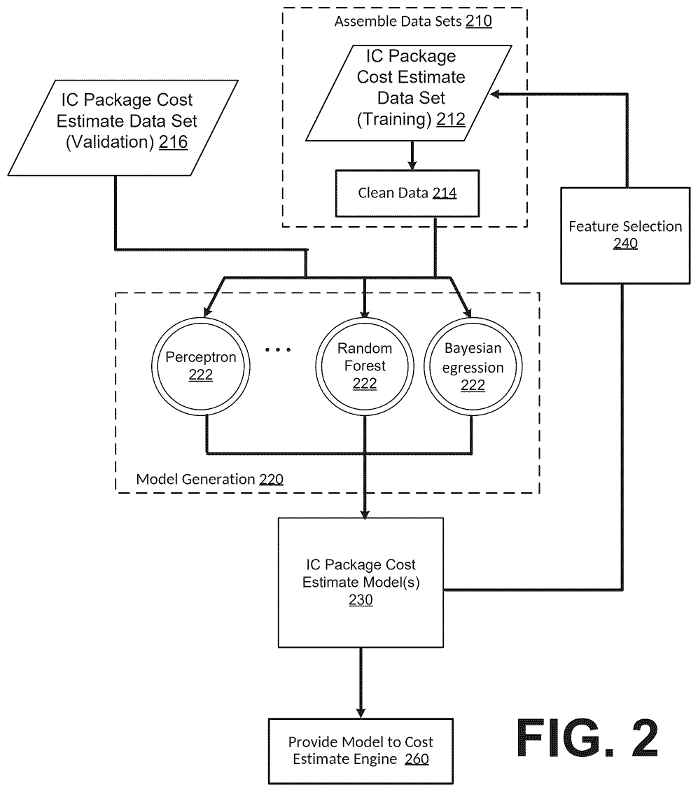

FIG. 2 is a hybrid data flow diagram showing an ML based IC package cost estimate model generation scheme in accordance with some embodiments. The hybrid data flow diagram includes a data assembly block 210, a model generation block 220, one or more package cost estimate models 230, a feature selection block 240, and a block 260 to make package cost estimate models available to a cost estimate engine.

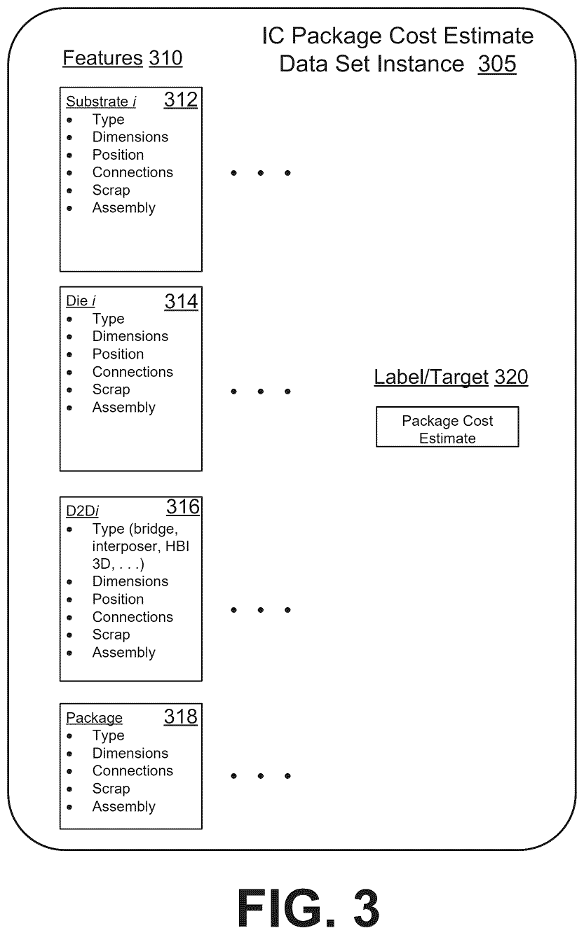

FIG. 3 shows an exemplary data set template for an IC package cost estimate model in accordance with some embodiments. The template instance includes a list of package features 310 and a cost label or cost estimate target, depending on whether the features are used for training or identifying a cost estimate by using a trained model. The package features include substrate features 312, die features 314, die-to-die (D2D) interconnect features 316, and package/package assembly features 318. The features are modeled as stacked parent/child relationships, breaking down each individual component (e.g., die, die prep, assembly, substrate, wafer, backend yield, die yield, etc.) as indicated.

In the depicted embodiment, there are multiple substrate features 312 including type (e.g., organic, silicon, glass), dimensions, position, connections/layers, scrap, and assembly. Some of these features are entered by a designer/user while others such as estimated scrap or assembly costs may be generated using feature generation engines with historical database models with heuristics to estimate these features based on the entered values and relationships to other features. For example, dimensions in the Z-axis (thickness) may be generated by the tool based on a number of entered layers, for substrates, interposers, dies, etc.

The die feature category 314 corresponds to the different dies, semiconductor, optical, or other that may be added to a package design. The die features include die type (e.g., memory, base die, system-on-chip, accelerator, etc.), die dimensions, die position (relative place in stack or within other dies), connection (e.g., to interposer, atop or below die, bridge, etc.), estimated scrap parameters, and other associated assembly costs.

The D2D feature category 316 includes D2D type (e.g., interposer, bridge, hybrid 3D bond, etc.), dimensions, position, connections, estimated scrap costs, and estimated assembly parameters. The package feature category 318 includes package type (e.g., plastic, epoxy, heat dissipation elements, etc.), dimensions, connections, scrap and assembly.

Returning back to FIG. 2, the data assembly block 210 includes assembling labeled sets of IC package feature instances (212) and cleaning the data 214 to make it amendable for ML model training 220. ML algorithm selection is among the initial choices to determine how the model will find patterns in the collected data. The algorithm stands behind the ML model. The same model can use various algorithms. Simultaneously with the choice of algorithm, the collected data may undergo a series of transformations to shape the training set. For example, the data may be edited, refined, labeled, and enhanced manually to achieve acceptable data quality for future models.

With the depicted implementation, the package data set instances are provided to one or more different ML model training engines 222. The model(s) are files containing the layers and weights that are trained to identify multiple correlations or patterns in the datasets. The models are trained from datasets using one or more of the machine learning algorithms, which are used to analyze and remember that learning data. As in the depicted embodiment, they may be used to generate, in parallel, a cost estimation model for each of the ML methods. In some embodiments, various different ML algorithms such as Bayesian Regression, Random Forest, Perceptron, Decision Tree, KNearest Neighbor, Model N, Model N−1, and Neural Network, among others, may be used for the ML model builders 222.

In some embodiments, a Bayesian algorithm, which is an extension of typical machine learning models, may be used. It can be used to evaluate model responses, adding uncertainty ranges/bands to a response. For example, these ranges may be uncertainties coming from not sufficiently addressing design feature(s) in a model frame. That is, the effects of left-out or insufficiently addressed design features can be quantified in a predictive cost range that can be narrowed down in later stages of product development.

A majority of the labeled package data sets 212 may be used for training, i.e., building the models, while remaining labeled data sets 216 may be used to test the models to assess their accuracy against actual package instance costs used as controls.

At 230, one or more models may be selected. In some embodiments, it has been found that Random Forest and Linear Regressor model building methods have provided preferred models. Random Forest, for example, models can not only provide cost estimates, but also, they can provide confidence ranges as well as breakdowns of which features are most influential on an accurate cost estimate prediction.

As shown in the diagram, features may be selected (or prioritized) at 240. For this block, SHAP charts may be generated from the generated model(s). The information in the charts including feature importance and correlations may be used at 240 for feature selection. SHAP analysis may also be used to better identify design features that are mainly contributing to the response (e.g., cost). (Note that SHAP, Shapley Additive explanations, is a game theoretic approach to explain the output of a machine learning model. For example, it may connect optimal credit allocation with local explanations using classic Shapley values from game theory and their related extensions.)

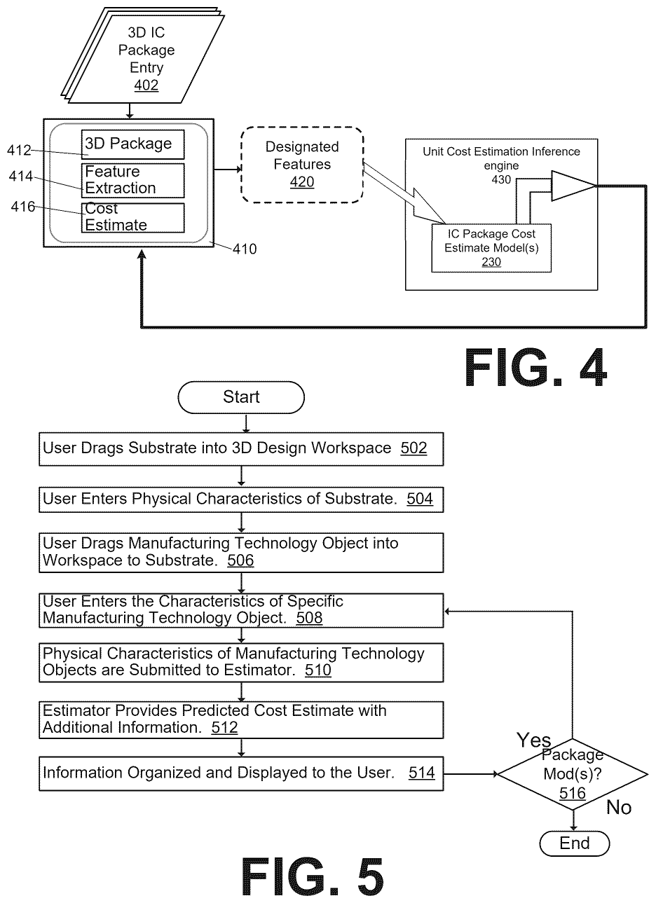

With this information, architecturally sensitive design features may be identified, allowing for such design features to be addressed earlier in a design flow process. The feature definitions and forms may be refined, e.g., based on a list of features that have higher predictive power, and used to refine existing and additional labeled training, and validation, training sets for tuning of the package cost estimate model. From here, the model may be used in a cost estimate engine as will be discussed below with reference to FIGS. 4-6.

FIG. 4 is a diagram illustrating an IC package cost estimation tool in accordance with some embodiments. The tool includes a 3D package user interface engine 410 that allows a user to virtually build an IC package design by entering package objects and parameters 402. The interface 410 displays and allows the user to build upon a 3D IC package design 412. As the package design is being defined, the interface engine extracts features 414 and provides them to a designated features engine 420, which organizes the feature information into a format that is suitable for processing by a cost estimation inference engine 430 using one or more IC package cost estimation models 230. Generated cost estimate information, along with feature contribution and confidence data, are then fed back to the user interface and displayed to the user at 416.

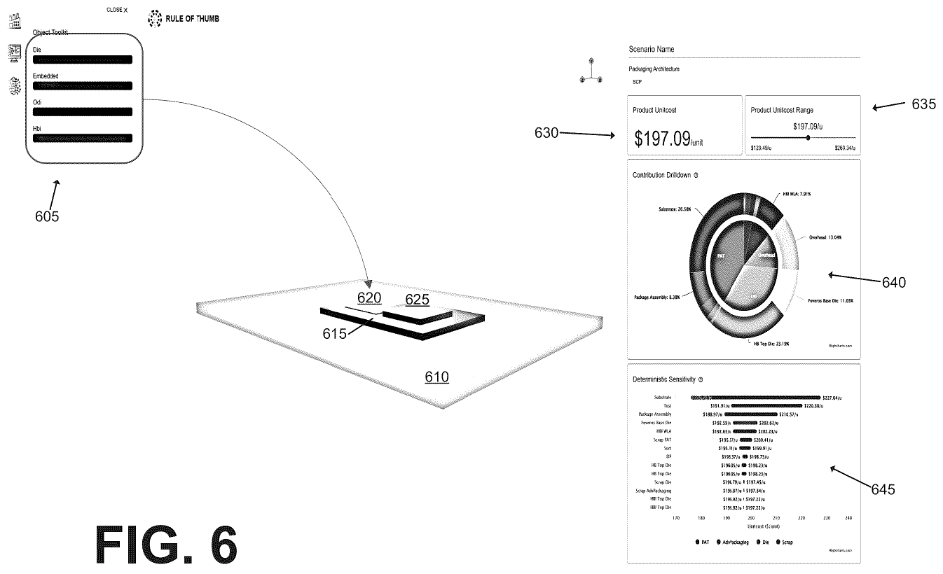

FIG. 5 is a flow diagram showing a process of estimating product unit cost through the application of the 3D interface of FIG. 4 in accordance with some embodiments. Additional reference is made to FIG. 6, which shows an exemplary user interface display in accordance with some embodiments.

At 502, the user starts by dragging a substrate (610) into the 3D workspace and at 504, the user enters (e.g., through a drop-down menu and or data entry field(s), technical information for the selected substrate. The user may select the substrate option, and later additional other objects, through an object tool area 605. Next, at 506 and 508, the user adds manufacturing technology objects to construct a desired package architecture into the 3D package design and then enter the required characteristics such as layer count, dimensions and wafer cost. IN the depicted interface, the user has added a base die 615 and first and second other dies 620, 625 mounted atop the base die, e.g., by way of hybrid bonding.

When the user has completed the package design, at 510, the features corresponding to the design are provided to the estimator 530. At 512, the estimator returns cost estimate and other information back to the interface at 514. For example, as shown in FIG. 6, the predicted unit cost value 630 and cost estimate range information 635 are displayed to the user. Also provided are cost drilldown and deterministic sensitivity charts (640, 645) of associated metrics for substrate, die, scrap and overhead, etc.

At 516, the routine determines if the user is finished or if revisions and/or additions are to be made. If so, then the routine loops back to 508, and the user updates the package design as described. After each change to the visual design or its parameters, the user is provided with an updated cost estimate and metrics.

In some embodiments, the estimator models each manufacturing technology object separately, using a unique machine learning model. This allows for emergent unit cost prediction of novel architectures and allows for greater flexibility in performing what-if analysis. The machine learning models can identify major design input contributors and use these dominant features to predict a unit cost. To a degree that other design inputs are ignored, cost fluctuations may arise, but the model can quantify those fluctuations as uncertainty bands as shown at 635.

In some embodiments, the cost estimation engine 430 may include design tool modules to impose boundary conditions to prevent a user from violating specified design rules. For example, an interposer or die may not be allowed to hang over a substrate edge. It may also include power and thermal simulation engines to indicate that the generated heat may sufficiently be removed with the designated thermal transfer hardware. In this way, a user may change component positions to identify suitable less costly package structures that still meet operational design requirements.

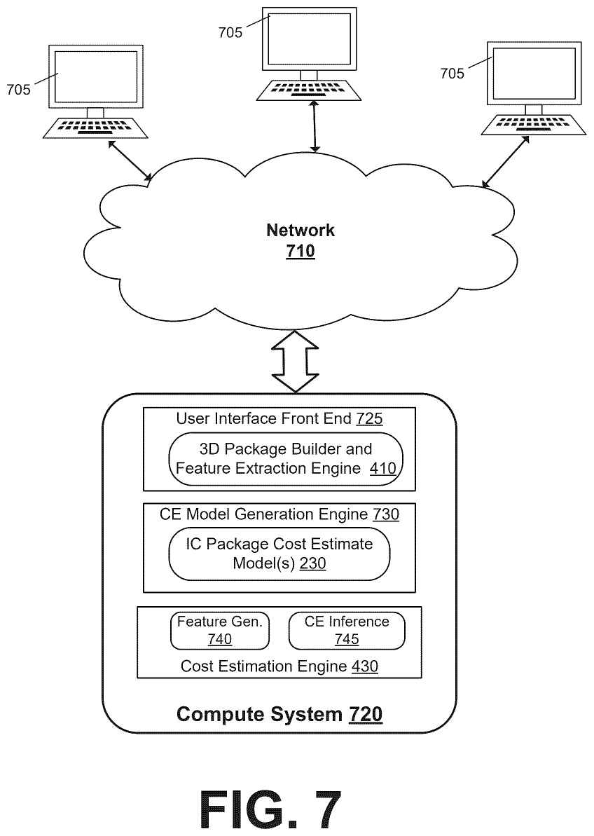

FIG. 7 is a block diagram of a server based network compute system for implementing an IC package design and cost estimation system in accordance with some embodiments. The system includes a plurality of terminal devices (PCs, servers, mobile workstations, etc.) 705 coupled to a server computing system 720 through network 710. Network 710 may comprise one or more local and/or wide area networks configured to provide users with secure, reliable, and efficient access to the server (compute) system 720. In some embodiments, this system may be used for providing cloud-based services to external users, it may implement a private network for internal design organization users, or it may implement combinations of both private internal and third-party external compute processing services whether or not provided through cloud-based open or de-coupled restricted network interfaces.

The server system 720 includes a plurality of servers such as HPC (high performance computer) and/or server pools coupled to one another to implement a user interface front end 725, model generation engine 730, and an IC package design and cost estimation engine 430 as is shown. The servers and constituent server computer devices may be located in a single location or geographically distributed across different physical locations.

The user interface front end 725 includes a 3D package design builder and feature extraction engine 410 as described above to allow a user to virtually build a desired 3D IC package and see the packaging costs and how they are affected by the various package parameters as the package design is created. The model generation engine 730 facilitates and maintains IC package design(s) 230, while the cost estimate engine 430 implements a feature generation engine 740 and a cost estimate inference engine 745.

The feature generation engine may calculate and/or pull data from several different databases relating to advanced package parameters to generate model feature data off of user entered data. Ongoing feature engineering and data cleaning, as discussed with regard to FIG. 2, may also be implemented in feature generation engine 740. The cost estimate inference engine 745 submits pertinent features, ultimately derived from a user's entered IC package design, into cost estimate model(s) 230 to generate cost estimate target values, along with the other statistical and contribution breakdown information discussed above.

Illustrative examples of the technologies disclosed herein are provided below. An embodiment of the technologies may include any one or more, and any compatible combination of, the examples described below.

Example 1 is a system that includes a user interface engine and a cost estimate engine. The user interface engine is to receive from a user a virtual integrated circuit (IC) package design and to extract from the package design parameter features. The cost estimation engine has at least one machine learning (ML) generated cost estimation model to generate a target cost estimate for the virtual IC package design based on the parameter features.

Example 2 includes the subject matter of example 1, and wherein the user interface engine includes a 3D package design builder to allow a user to virtually construct the IC package design from a set of available package objects.

Example 3 includes the subject matter of any of examples 1-2, and wherein the set of package objects includes a substrate object and a die object.

Example 4 includes the subject matter of any of examples 1-3, and wherein the set of package objects includes a die-to-die (D2D) connector object.

Example 5 includes the subject matter of any of examples 1-4, and wherein the D2D connector object includes a bridge object.

Example 6 includes the subject matter of any of examples 1-5, and wherein the D2D connector object includes an interposer object.

Example 7 includes the subject matter of any of examples 1-6, and wherein the cost estimate includes a cost estimate range.

Example 8 includes the subject matter of any of examples 1-7, and wherein the model is derived from a Random Forest machine learning model generation process.

Example 9 includes the subject matter of any of examples 1-8, and wherein the cost estimation engine is to generate a chart indicating a breakdown of package object contributions to the generated cost estimate.

Example 10 includes the subject matter of any of examples 1-9, and wherein the cost estimation engine is to use a subset of the extracted features based on their historical importance in generating an accurate package cost estimate.

Example 11 includes the subject matter of any of examples 1-10, and wherein the cost estimation engine includes a feature generation engine to generate derived features based on features extracted from the package design.

Example 12 includes the subject matter of any of examples 1-11, and wherein the Example 13 includes the subject matter of any of examples 1-12, and wherein the derived features include thermal parameters based on package object types.

Example 14 is a computer readable storage medium having instructions that when executed by one or more computing devices performs a method. The method includes providing on a display a user interface including an integrated circuit (IC) package design area. It also includes receiving from a user an IC package design constructed from package objects made available through the user interface. It further includes extracting from the IC package design parameter features and generating a target cost estimate for the IC package design using a machine learning (ML) trained model based on the extracted parameter features.

Example 15 includes the subject matter of example 14, and wherein the user interface implements a 3D package design builder to allow a user to virtually construct the IC package design from the available package objects.

Example 16 includes the subject matter of any of examples 14-15, and wherein the set of package objects includes substrate objects and die objects.

Example 17 includes the subject matter of any of examples 14-16, and wherein the package objects includes die-to-die (D2D) connector objects.

Example 18 includes the subject matter of any of examples 14-17, and wherein the D2D connector objects include a bridge object.

Example 19 includes the subject matter of any of examples 14-18, and wherein the D2D connector objects include an interposer object.

Example 20 includes the subject matter of any of examples 14-19, and wherein the cost estimate includes a cost estimate range.

Example 21 includes the subject matter of any of examples 14-20, and wherein the ML model is derived from a Random Forest machine learning model generation process.

Example 22 includes the subject matter of any of examples 14-21, and wherein the method includes generating through the user interface a chart indicating a breakdown of package object contributions to the cost estimate.

Example 23 includes the subject matter of any of examples 14-22, and wherein the method uses a subset of the extracted features based on their historical importance in generating the package cost estimate.

Example 24 includes the subject matter of any of examples 14-23, and wherein the method is to generate derived features based on features extracted from the package design.

Example 25 includes the subject matter of any of examples 14-24, and wherein the derived features include thermal parameters based on relative package object positions.

Example 26 includes the subject matter of any of examples 14-25, and wherein the derived features include thermal parameters based on package object types.

Example 27 is a computer implemented integrated circuit (IC) package design system that includes a server system. The server system has executable code to implement a user interface engine to receive from a user a virtual integrated circuit (IC) package design and to extract from the package design parameter features. The server system also has executable code to further implement a cost estimation engine having at least one machine learning (ML) generated cost estimation model to generate a target cost estimate for the virtual IC package design based on the parameter features, wherein the user interface engine includes a 3D package design builder to allow a user to virtually construct the IC package design from a set of available package objects.

Example 28 includes the subject matter of example 27, and wherein the set of package objects includes a substrate object and a die object.

Example 29 includes the subject matter of any of examples 27-28, and wherein the set of package objects includes a die-to-die (D2D) connector object.

Example 30 includes the subject matter of any of examples 27-29, and wherein the D2D connector object includes a bridge object.

Example 31 includes the subject matter of any of examples 27-30, and wherein the D2D connector object includes an interposer object.

Example 32 includes the subject matter of any of examples 27-31, and wherein the cost estimate includes a cost estimate range.

Example 33 includes the subject matter of any of examples 27-32, and wherein the model is derived from a Random Forest machine learning model generation process.

Example 34 includes the subject matter of any of examples 27-33, and wherein the cost estimation engine is to generate a chart indicating a breakdown of package object contributions to the generated cost estimate.

Example 35 includes the subject matter of any of examples 27-34, and wherein the cost estimation engine is to use a subset of the extracted features based on their historical importance in generating an accurate package cost estimate.

Example 36 includes the subject matter of any of examples 27-35, and wherein the cost estimation engine includes a feature generation engine to generate derived features based on features extracted from the package design.

Example 37 includes the subject matter of any of examples 27-36, and wherein the derived features include thermal parameters based on relative package object positions.

Example 38 includes the subject matter of any of examples 27-37, and wherein the derived features include thermal parameters based on package object types.

As used in this specification, the term “embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

Throughout the specification, and in the claims, the term “connected” means a direct connection, such as electrical, mechanical, or magnetic connection between the things that are connected, without any intermediary devices.

The term “coupled” means a direct or indirect connection, such as a direct electrical, mechanical, or magnetic connection between the things that are connected or an indirect connection, through one or more passive or active intermediary devices.

The term “circuit” or “module” may refer to one or more passive and/or active components that are arranged to cooperate with one another to provide a desired function. Different circuits or modules may share ore even consist of common components. for example, A controller circuit may be a circuit to perform a first function and at the same time, the same controller circuit may also be a circuit to perform another function, related or not related to the first function.

The terms “substantially,” “close,” “approximately,” “near,” and “about,” generally refer to being within +/−10% of a target value.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

It is pointed out that those elements of the figures having the same reference numbers (or names) as the elements of any other figure can operate or function in any manner similar to that described but are not limited to such.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

As defined herein, the term “computer readable storage medium” means a storage medium that contains or stores program code for use by or in connection with an instruction execution system, apparatus, or device. As defined herein, a “computer readable storage medium” is not a transitory, propagating signal per se. A computer readable storage medium may be, but is not limited to, an electronic storage device, a magnetic storage device, an optical storage device, an electromagnetic storage device, a semiconductor storage device, or any suitable combination of the foregoing. Memory elements, as described herein, are examples of a computer readable storage medium. A non-exhaustive list of more specific examples of a computer readable storage medium may include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

As defined herein, the term “output” means storing in physical memory elements, e.g., devices, writing to display or other peripheral output device, sending or transmitting to another system, exporting, or the like.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

As defined herein, the terms “one embodiment,” “an embodiment,” or similar language mean that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

As defined herein, the term “processor” means at least one hardware circuit configured to carry out instructions contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a graphics processing unit (GPU), a controller, and so forth.

A computer program product may include a computer readable storage medium (or media) having computer readable program instructions thereon for causing a processor to carry out aspects of the inventive arrangements described herein. Within this disclosure, the term “program code” is used interchangeably with the term “computer readable program instructions.” Computer readable program instructions described herein may be downloaded to respective computing/processing devices from a computer readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations for the inventive arrangements described herein may be assembler instructions, instruction-set-architecture (ISA) instructions, machine instructions, machine dependent instructions, microcode, firmware instructions, or either source code or object code written in any combination of one or more programming languages, including an object oriented programming language and/or procedural programming languages. Computer readable program instructions may include state-setting data. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the internet using an Internet Service Provider). In some cases, electronic circuitry including, for example, programmable logic circuitry, an FPGA, or a PLA may execute the computer readable program instructions by utilizing state information of the computer readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer readable program instructions, e.g., program code.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the operations specified in the flowchart and/or block diagram block or blocks.

The flowchart and block diagrams in the figures illustrate the architecture, functionality, and operation of possible implementations of systems, methods, and computer program products according to various aspects of the inventive arrangements. In this regard, each block in the flowchart or block diagrams may represent a module, segment, or portion of instructions, which comprises one or more executable instructions for implementing the specified operations.

In some alternative implementations, the operations noted in the blocks may occur out of the order noted in the figures. For example, two blocks shown in succession may be executed substantially concurrently, or the blocks may sometimes be executed in the reverse order, depending upon the functionality involved. In other examples, blocks may be performed generally in increasing numeric order while in still other examples, one or more blocks may be performed in varying order with the results being stored and utilized in subsequent or other blocks that do not immediately follow. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

What is claimed is:

1. A system, comprising:
a user interface engine to receive from a user a virtual integrated circuit (IC) package design and to extract from it design parameter features; and
a cost estimation engine having at least one machine learning (ML) generated cost estimation model to generate a target cost estimate for the virtual IC package design based on the design parameter features.

2. The system of claim 1, wherein the user interface engine includes a 3D package design builder to allow a user to virtually construct the IC package design from a set of available package objects.

3. The system of claim 2, wherein the set of package objects includes a substrate object and a die object.

4. The system of claim 3, wherein the set of package objects includes a die-to-die (D2D) connector object.

5. The system of claim 4, wherein the D2D connector object includes a bridge object.

6. The system of claim 4, wherein the D2D connector object includes an interposer object.

7. The system of claim 1, wherein the cost estimate includes a cost estimate range.

8. The system of claim 7, wherein the model is derived from a Random Forest machine learning model generation process.

9. The system of claim 1, wherein the cost estimation engine is to generate a chart indicating a breakdown of package object contributions to the generated cost estimate.

10. The system of claim 1, wherein the cost estimation engine is to use a subset of the extracted features based on their historical importance in generating an accurate package cost estimate.

11. The system of claim 1, wherein the cost estimation engine includes a feature generation engine to generate derived features based on features extracted from the package design.

12. The system of claim 11, wherein the derived features include thermal parameters based on relative package object positions.

13. The system of claim 12, wherein the derived features include thermal parameters based on package object types.

14. A computer readable storage medium having instructions that when executed by one or more computing devices performs a method comprising:
providing on a display a user interface including an integrated circuit (IC) package design area;
receiving from a user an IC package design constructed from package objects made available through the user interface;
extracting from the IC package design design-parameter features; and
generating a target cost estimate for the IC package design using a machine learning (ML) trained model based on the extracted design-parameter features.

15. The medium of claim 14, wherein the cost estimate includes a cost estimate range.

16. The medium of claim 15, wherein the ML model is derived from a Random Forest machine learning model generation process.

17. The medium of claim 14, wherein the method uses a subset of the extracted design-parameter features based on their historical importance in generating the package cost estimate.

18. A computer implemented integrated circuit (IC) package design system, comprising:
a server system having executable code to implement a user interface engine to receive from a user a virtual integrated circuit (IC) package design and to extract from it design parameter features; and
the server system executable code to further implement a cost estimation engine having at least one machine learning (ML) generated cost estimation model to generate a target cost estimate for the virtual IC package design based on the design parameter features, wherein the user interface engine includes a 3D package design builder to allow a user to virtually construct the IC package design from a set of available package objects.

19. The system of claim 18, wherein the cost estimate includes a cost estimate range.

20. The system of claim 19, wherein the model is derived from a Random Forest machine learning model generation process.
